(19) United States
(12) Patent Application Publication
(10) Pub. No.: US 2010/0028325 A1
(43) Pub. Date: Feb. 4, 2010

(54) New Combination Of Cationic Preservatives With Taste-Masking Components

(75) Inventors: Xavier Rocabayera Bonvila, Palau-Solita (ES); Sergi Figueras Roca, Barcelona (ES); Roger Segret Pons, Barcelona (ES); Eva Piera Eroles, Barcelona (ES)

Correspondence Address: RANKIN, HILL & CLARK LLP, 23755 Lorain Road - Suite 200, North Olmsted, OH, 44070-2224, US

(73) Assignee: LABORATORIOS MIRET, S.A., Terrassa, Barcelona (ES)

(21) Appl. No.: 12/525,718

(22) PCT Filed: Feb. 7, 2007
(86) PCT No.: PCT/EP07/51168

§ 371 Date: Sep. 16, 2009

(51) Int. Cl. A01N 63/00; A01N 37/12; A01P 1/00

(52) U.S. Cl. 424/94.61; 514/551

(57) ABSTRACT

Use of cationic surfactants, derived from the condensation of fatty acids and esterified dibasic amino acids, of the formula (1):

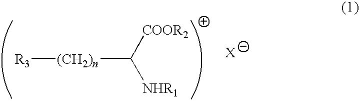

occasionally leads to a bitter taste, when the compound is present in a large concentration. The bitter taste can be masked by combination with a second component selected from the list consisting of sucralose, neohespiridin (NHDC), β-cyclodextrin, mono ammonium glycyrrhizinate (MAG), banana, mentholyptus, sodium dodecyl sulphate (SDS), anetol, menthol, thaumatin, adenosine monophosphate (AMP), aloten, arginine, sodium acetate, arilic acids (ferulic acid, caffeic acid), sclareolide, maltol, anane, phosphatidic acid, eucalyptol, lactisole, lysozyme, lactoglobulin, timol, borneol, acetol, phosphothreonine, phosphotyrosine, phosphoserine, Masking flavour 501521T, Masking flavour 501522, saccharine, aspartame, MK22 N&A FL for masking #25682, MM24 Prosweet N&A FL Enhancer, neodiosmin, xylitol, stevia and Natural and Functional Flavour (NAF®).

This invention relates to new combinations with antimicrobial action on the basis of cationic surfactants.

In the art it is known to use a preservative system which comprises a cationic surfactant which is derived from the condensation of fatty acids and esterified dibasic amino acids, and having the formula (1):

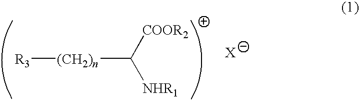

where:
X⁻ is a counter ion derived from an inorganic or organic acid, preferably Br⁻, Cl⁻, or HSO₄⁻
R₁: is a straight alkyl chain of a saturated fatty acid or a hydroxy acid having 8 to 14 carbon atoms linked to the α-amino group via an amide bond,
R₂: is a straight or branched alkyl chain from 1 to 18 carbon atoms or an aromatic group and

### R₃: is:

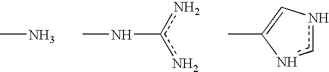

where n is from 0 to 4.

Cationic surfactants are known as preservatives used in the food industry. Due to their composition, food products are regularly susceptible to act as a culture medium for micro-organisms and this constitutes a possible risk to human health. Thus, food products require good protection against microbial contamination. During long-time use the class of the cationic surfactants has turned out to be highly effective against microbial proliferation and at the same time safe for intake in humans and mammals in general, which has made them an attractive tool in the food industry.

Cationic surfactants are also known as preservatives used in cosmetic products. Due to their composition, many cosmetic products are prone to act as a culture medium for micro-organisms. This may lead to changes in the cosmetic preparation and can possibly constitute a risk to human health. Thus, a cosmetic preparation necessarily requires good protection against microbial contamination. To achieve this purpose, a large number of preservatives to inhibit or reduce the microbial population is used.

Cationic surfactants of the above formula (1) also display a surprising, remarkably strong antiviral activity. This class of compounds is besides its antimicrobial action in food and cosmetic products recently described for its antivirus activity against Vaccinia, Herpes simplex and bovine parainfluenzae virus types. This is described in the patent application PCT/EP2006/065035.

It has been demonstrated that cationic surfactants according to formula (1) derived from lauric acid and arginine are highly effective protective substances against micro-organisms. In particular the ethyl ester of the lauramide of the arginine monohydrochloride, hereafter referred to as LAE, is now well-known for its use as an antimicrobial agent. In practical use LAE turned out to be well tolerated and to display a very low toxicity to human beings. LAE has the chemical structure of formula (2) displayed hereafter.

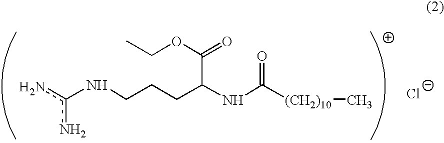

The compound LAE is remarkable for its activity against different micro-organisms, like bacteria, moulds and yeasts which can be present in food products (WO 03/034842) and also in cosmetic formulations and preparations (WO 03/013453, WO 03/013454 and WO 03/043593). The product is outstanding for its innocuity to humans.

The general preparation of the cationic surfactants is described in Spanish patent ES 512643 and international patent applications WO 96/21642, WO 01/94292 and WO 03/064669.

Interactions between the cationic surfactants and other molecules are known. A combination of the cationic surfactants with anionic hydrocolloids is described in WO 03/094638, this combination leads to the generation of solid products containing approximately stoichiometric amounts of the cationic surfactant and the anionic hydrocolloid. A further combination of the cationic surfactants is described in WO 02/087328, this combination relating to potassium sorbate, calcium sorbate or sorbic acid, which turned out to be highly effective in food preservation.

The preservative systems described in WO 02/087328 are characterised by their synergistic activity. It has now been found that the antimicrobial activity of the combinations of LAE and the other compounds defined by the above formula (1) with most of the common ionic and non-ionic preservatives used to protect food products and also cosmetic formulations and preparations is higher than the activity displayed by each of the components when used alone at the same dosage. There has been observed synergism when the amounts of the compounds of formula (1) and the other antimicrobial are reduced. Thus, the adverse toxic effects and/or irritation and/or allergy displayed by the combinations of the preservatives have also been reduced.

In the practical use of the cationic surfactants of formula (1) in food preparations and orally applied cosmetics it has been observed now and then, that at high dose levels of the compounds, the original taste of the matrix is changed where they are applied. Usually, the own taste of the cationic surfactants of formula (1) is not observed and it may be completely covered by other ingredients. However, under circumstances where it is required to use relatively high concentrations for the intended preservation, the taste may be experienced as an unwanted sensation, and the consumer may find the own taste of the final matrix (food or oral cosmetic) changed. The specific cases where it has been found that the taste of the matrix is changed by the presence of the cationic surfactant are: beverages, dairy products such as for instance creams, food matrices destined for consumption by immunodepressed people that should contain high dose levels of cationic surfactants to protect food product against microbial spoilage and oral cosmetics like toothpaste and mouthwash.

In some specific organoleptic experiments performed in beverages and toothpaste treated with the cationic surfactant of formula (2), i.e. LAE, the consumer perceived the sensation of bitter taste. The oral sensation of bitter taste is often unpleasant to the human palate and therefore formulations of food, beverages and oral cosmetics attempt to alleviate or ameliorate the bitter taste perception.

There are several accepted theories describing the mechanisms of perception of sweetness and bitterness. All of them agree that a bitter compound and a sweet compound bind independently at the same specific receptors. A bitter compound and a sweet compound bind at the same receptor in a “competitive” manner. As a result of this competitive mechanism, both flavours become altered.

The requirement for bitterness is the presence of an electrophilic group (AH) and an hydrophobic group (X). The electrophilic species (AH) binds to a receptor site (A′) via an amino- or hydrophobic group. In order for a compound to be perceived as bitter, the AH group must bind to A′, a second hydrophobic group X must bind to a second site X′ and a third site B′ must be free in order to produce bitterness. An inhibitor of bitter taste only fills B′ and X′.

The use of sweeteners or flavouring agents is well-known in various parts of the technique to reduce or inhibit the bitter taste. There is for instance an understandable interest in masking the bitter taste of pharmaceutical agents in order to guarantee acceptance by the patients. Such masking may be achieved by the addition of any product which displays a more convenient taste which may be suitable to cover the unpleasant taste of the pharmaceutical agent itself. The added product may be just one further component in the composition, it can also be provided in the form of a layer which retards the availability of the active ingredient with the bad taste.

The usual methods in the pharmaceutical industry will not be suitable for use in food products. Usually, the preservative shall be available immediately to display its antimicrobial action and covering it with some kind of protective layer may lead to a loss of this activity.

Addition of any masking agent is possible, provided that it is suitable to neutralize the characteristic taste of the cationic surfactants of formula (1). The best known ones in the traditional art of cooking are salt and sugar, but the range of further options is practically unlimited. Any particular choice will depend on the type of food- or cosmetic product which is preserved and more in particular on the own taste and flavour of the food- or cosmetic product.

It is an object of the present invention to provide a combination of a cationic surfactant of formula (1) with an added component which does not change the characteristic taste of the product (matrix) where the cationic surfactant is applied. In the combination the final intention is the lack of the bitter sensation taste at all or the sensation of the taste or flavour of the added component. At the same time, the antimicrobial effect of the cationic surfactants shall not be influenced through the additional presence of the taste masking agent.

The object of the invention has been solved by providing the cationic surfactants of above formula (1) in combination with a further ingredient, selected from the group consisting of the following list. The cationic surfactant may be combined with one ingredient in the following list, or with a mixture of two or more of the ingredients from the following list.

| | | | |
|---|---|---|---|
| Sucralose | Neohespiridin | β-cyclodextrin | Mono ammonium |
| | (NHDC) | | glycyrrhizinate (MAG) |
| Banana | Mentholyptus | Phosphothreonine | Sodium dodecylsulfate |
| | | | (SDS) |
| Anetol | Menthol | Thaumatin | Adenosine |
| | | | monophosphate |
| | | | (AMP) |
| Aloten | Arginine | Sodium acetate | Arilic acids |
| | | | (ferulic, caffeic) |
| Sclareolide | Maltol | Anane | Phosphatidic acid |
| Eucalyptol | Lactisole | Lysozyme | Lactoglobuline |
| Timol | Borneol | Acetol | Phosphotyrosine |
| Masking | Saccharine | Aspartame | MK22 N&A FL for |
| flavour | | | masking #25682 |
| 501521T | | | |
| Masking | Neodiosmin | Phosphoserine | MM24 Prosweet N&A |
| flavour | | | FL Enhancer |
| 501522T | | | |
| Xylitol | Stevia | Natural and | |
| | | Functional | |
| | | Flavour (NAF ®) | |

It turned out rather surprisingly, that this limited choice of added components leads to the final result which is completely satisfactory, that is to inhibit or to neutralize the bitter taste.

The substances in the list are artificial sweeteners, flavouring agents, enzymes, salts, amino acids, ionic surfactants or proteins.

From the list, the most preferred masking agents to mask or reduce the bitter taste produced by cationic surfactants of formula (1) are: sucralose, lysozyme, neohespiridin (NH DC), β-cyclodextrin, mono ammonium glycyrrhizinate (MAG), sodium dodecylsulfate (SDS), sodium acetate, masking flavour 501521T, masking flavour 501522T, NAF®, MK22 N&A FL for masking #25682, MM24 Prosweet N&A FL Enhancer, mentholyptus, menthol and xylitol.

It has been found that the compounds from the list provide a satisfactory taste alone or in combination with one or more further product from the above list. Particularly suitable combinations in food matrices are the combination of the NAF® products with neohespiridin and sucralose. For cosmetic preparations a further combination with a remarkable efficacy is the combination of sodium dodecyl sulphate with sucralose, this combination can be further improved by the addition of neohespiridin or neohespiridin and glycyrhizzinate. A further combination with a surprising efficacy is the combination of mentholyptus or menthol with xylitol and sucralose.

Although it seems evident to think that the combination of an agent of bitter taste with a sweetener agent should provide a neutral taste, it was a surprising observation from numerous experiments, that the combination of a cationic surfactant of formula (1) with high doses of sugar or the following polyols: lactitol, mannitol and sorbitol does not neutralise the bitter taste characteristic of the cationic surfactant. Other experiments have demonstrated, that for the neutralisation of the taste of a matrix a specific combination of a masking agent with the cationic surfactant is required, and this specific combination must be used at a determined dose level. When the relationship between masking agents is altered or when one of the masking agents is deleted from a proposed combination it is possible to observe that the taste is changed. Thus, there is no universal inhibitor of all bitter-tasting substances.

As previously mentioned, there are some patents and patent applications reporting the efficacy of the cationic surfactant of the formula (1) and more specifically of the formula (2) in oral care products like toothpaste and mouthwash products and in a wide range of food products (i.e.: beverages, meat products, dairy products, ready-to-eat meals, etc). Due to the physical properties of some products destined to human consumption, sometimes it is necessary to add a high dose level of the cationic surfactant of the formula (1) and more specifically of the formula (2) in order to avoid the microbial spoilage of the product.

The cationic surfactants of formula (1) may be combined with the masking agents at a weight ratio of 1:300 to 2,000:1. A preferred weight ratio is between 1:50 and 200:1. The specific range may depend on the type of product to be preserved, the type of the cationic surfactant and the kind of taste masking agent.

A typical concentration of the preservatives of formula (1) in food products is between 1 ppm and 10,000 ppm. A preferred concentration is in the range of 1 to 1,000 ppm, a more preferred range between 10 and 200 ppm, an even more preferred range between 10 and 100 ppm. Although the preferred ranges are in a low concentration range, the use in the higher concentrations is regularly observed.

A typical concentration of the preservatives of formula (1) in cosmetic preparations is between 1 ppm and 15,000 ppm. A preferred concentration is in the range of 200 to 10,000 ppm, a more preferred range between 500 and 10,000 ppm, an even more preferred range between 800 and 8,000 ppm. The use in higher or lower concentrations is often observed.

It has been described that the preferred species LAE is effective for use as a preservative agent in products consumed by immunodeficient persons (PCT/EP2006/065035). The administration of LAE to this type of affected persons through food products requires the application of high dose levels in order to prevent the food spoilage. Obviously, when the concentration of a substance is considerably high, this is perceived by the consumer. Such high dose levels of LAE can modify the characteristic taste of a product. In accordance to this, the present invention is focussed on reducing the alteration of the taste of products trough the combination of the cationic surfactant defined in formula (1) which has an antimicrobial action with one of the masking agents reported in the previous list. This is a particularly preferred use of the combinations according to the present invention.

When the cationic surfactants of the formula (1) are combined in food preparations with sodium dodecyl sulfate (SDS) it is possible to achieve a favourable result when SDS is present in an amount of 4 to 25 times, preferably between 6 to 20 times the amount of the cationic surfactant. If the concentration of the cationic surfactant is for instance 200 ppm, the corresponding concentration of SDS in the combination is between 800 and 5,000 ppm, preferably between 1,200 and 4,000 ppm.

When the cationic surfactants of the formula (1) are combined with mono ammonium glycyrhizzinate in food preparations, it is possible to achieve a favourable result when mono ammonium glycyrhizzinate is present in an amount of 1 to 20 times, preferably between 1 and 10 times the amount of the cationic surfactant. If the concentration of the cationic surfactant is for instance 200 ppm, the corresponding concentration of sodium dodecyl sulfate in the combination is between 200 and 4,000 ppm, preferably between 400 and 2,000 ppm.

When the cationic surfactants of the formula (1) are combined with only the masking agent NAF®, it is possible to mask the bitter taste. When the cationic surfactants of formula (1) are combined with a mixture of NAF® with a further masking agent, organoleptic data may prove the surprising improvement to a taste which is hardly detectable. A highly suitable combination is for instance the combination of NAF® with small amounts of sucralose and neohespiridin.

Similar results are achieved in cosmetic preparations. There are some differences. When a cationic surfactant of formula (1) is only combined with SDS, the toothpaste has a smooth taste. When the sample treated with the cationic surfactant of formula (1) contains a mixture of masking agents, such as the combination of SDS with sucralose, the taste of the sample is surprisingly neutralised, and even when the content of SDS versus sucralose is considerably increased, the taste is surprisingly improved. Besides, when the SDS is also combined with sucralose and NAF®C and NHDC the taste is surprisingly improved in comparison with those samples treated only with the cationic surfactant of formula (1) and SDS.

Thus, it is observed that there is no evident combination of different masking agents at different dose levels to neutralise the taste. The combinations that imply a surprising results with a pleasant taste in cosmetic preparations are:

(1) 7,500 ppm LAE+5,000 ppm sucralose+60 ppm NHDC+6,000 Masking flavour 501521T+5,000 ppm NAF®C+1,000 ppm glycyrhizzinate,

(2) 7,500 ppm LAE+5,000 ppm mentholyptus+13,000 ppm xylitol+1,000 ppm sucralose, and

(3) 7,500 ppm LAE+2,000 ppm menthol+15,000 ppm xylitol+2,000 ppm sucralose.

On the other hand, it is observed that the taste effect of combining a cationic surfactant of formula (1) with a masking agent or a mixture of masking agents also depends on the specific kind of cationic surfactant. The preferred species is LAE (formula 2), other possible cationic surfactants are: methyl-decanoyl-lysine acetate (MDLA), ethanol myristyl arginine lactate (EMAL), methyl lauroyl arginine chloride (MLAC) and ethanol lauroyl lysine chloride (ELLC). It has been found, that the combination of MDLA with a masking agent or a mixture of masking agents improves the taste of the food matrix or the cosmetic preparation, but not as well as in corresponding samples in which the cationic surfactant was LAE.

### EXAMPLES

The invention is described in more detail in the following examples and comparative examples.

### Example 1

The combination of the test compound neohespiridin (NHDC) with LAE was investigated in a carbonated oral juice drink (a base sugar syrup with concentrated organic juice, manufactured by Hausmann S.A.).

NHDC was produced by Ferrer grupo, LAE was produced by Laboratorios Miret S.A.

A control solution of 200 ppm LAE in the juice drink was prepared.

The test samples were prepared by direct dissolution of the test compound in the control solution. The test samples were compared with the control solution and with an untreated (blank) juice drink.

The evaluation of the taste was based on the article titled “Reduction of saltiness and bitterness after a chlorhexidine rinse”, Chem. Senses 26: 105-116 (2001). The following scale of values is defined from an organoleptic point of view: 1-no taste; 2-hardly detectable; 3-smooth taste; 4-moderated taste; 5-strong taste; 6-very hard taste and 7-unbearable taste.

The organoleptic studies were performed with a panel of 10 persons who were trained in experiments involving the tasting of bitter constituents. The panel was asked to compare samples containing a cationic surfactant alone or combined with one or more masking agent. The members of the panel were asked to indicate which sample was less bitter, thereby taking into account the scale of values defined as given above.

The results of the study are given in table 1.

### Example 2

The combination of the test compound sucralose (producer: Ferrer grupo) with LAE was investigated in the manner as described in example 1.

The results of the study are given in table 1.

### Example 3

The combination of the test compound lysozyme (producer: RADA) with LAE was investigated in the manner as described in example

The results of the study are given in table 1.

### Example 4

The combination of the test compound monoammonium glycyrrhizinate (producer: Cognis) with LAE was investigated in the manner as described in example 1.

The results of the study are given in table 1.

### Example 5

The combination of the test compound sodium acetate (producer: Panreac) with LAE was investigated in the manner as described in example 1.

The results of the study are given in table 1.

### Example 6

The combination of sodium dodecyl sulfate (SDS; producer: Merck) with LAE was investigated in the manner as described in example 1.

The results of the study are given in table 1.

### Example 7

The combination of MK22 N&A FL for masking #25682 (MK22, producer: Virginia Dare) with LAE was investigated in the manner as described in example 1.

The results of the study are given in table 1.

### Example 8

The combination of MM24 Prosweet N&A FL Enhancer (MM24, producer: Virginia Dare) with LAE was investigated in the manner as described in example 1.

The results of the study are given in table 1.

### Example 9

The combination of β-cyclodextrin (producer: Wacker) with LAE was investigated in the manner as described in example 1.

The results of the study are given in table 1.

### Comparative Example 1

The combination of plain sugar (producer: Quimidroga) with LAE was investigated in the manner as described in example 1.

The results of the study are given in table 2.

### Comparative Example 2

The combination of brown sugar (produced by Imperial sugar) with LAE was investigated in the manner as described in example 1.

The results of the test are given in table 2.

### Comparative Example 3

The combination of sodium glutamate (produced by Fluka) with LAE was investigated in the manner as described in example 1. The results of the study are given in table 2.

TABLE 1

| | Organoleptic |
|---|---|
| Sample | results |
| Blank | 1.3 |
| Control | 4.8 |
| NHDC (1 ppm) | 2.5 |
| Sucralose (5 ppm) | 2.7 |
| Lysozyme (500 ppm) | 2.5 |
| Lysozyme (2,500 ppm) | 2 |
| Glycyrrhizinate (250 ppm) | 2.3 |
| Glycyrrhizinate (500 ppm) | 2 |
| Glycyrrhizinate (1,000 ppm) | 2 |
| sodium acetate (1,000 ppm) | 2.8 |
| sodium acetate (10,000 ppm) | 2.3 |
| SDS (1,330 ppm) | 2.9 |
| SDS (1,960 ppm) | 2.3 |
| SDS (3,320 ppm) | 1.6 |
| MK22 (1,000 ppm) | 1.9 |
| MM24 (1,000 ppm) | 2.0 |
| β-cyclodextrin (1,000 ppm) | 2.1 |

TABLE 2

| | Organoleptic |
|---|---|
| Sample | results |
| Blank | 1.3 |
| Control | 4.8 |
| sugar (10,000 ppm) | 5.0 |
| sugar (60,000 ppm) | 4.8 |
| brown sugar (10,000 ppm) | 4.9 |
| brown sugar (60,000 ppm) | 4.7 |
| sodium glutamate (1,000 ppm) | 5.0 |
| sodium glutamate (60,000 ppm) | 4.8 |

### Example 10

The combination of LAE with only one masking agent, NAF®, was compared with a combination of several masking agents (one of these being NAF®) in carbonated orange juice drinks.

The manner of determination of the organoleptic results is the same as described in example 1. The results are reported in the following table 3 where a solution A is compared with a solution B.

Composition of solutions (all containing 200 ppm LAE):

### Solution A: 250 ppm NAF®

Solution B: 250 ppm NAF®+50 ppm sucralose+3 ppm NHDC,
Control solution: no masking agent.

Different types of NAF® are investigated (i.e.: NAF® C lemon, NAF® C Orange, etc., all produced by Ogawa).

LAE was produced by Laboratorios Miret S.A., sucralose by Ferrer grupo and NHDC by Ferrer grupo.

The carbonated orange juice drink is produced by Hausmann S.A.

TABLE 3

| | Organol. | | Organol. |
|---|---|---|---|
| Solution A | result | Solution B | result |
| Control | 4.8 | Control | 4.8 |
| NAF ® C Lemon | 2.8 | NAF ® C Lemon | 2.1 |
| NAF ® C Grapefruit | 2 | NAF ® C Grapefruit | 1.7 |
| NAF ® C Orange | 2 | NAF ® C Orange | 1.2 |
| NAF ® CE Orange | 2.5 | NAF ® CE Orange | 2.0 |
| NAF ® CE Lemon | 2.7 | NAF ® CE Lemon | 1.8 |

### Example 11

Determination of the taste in toothpaste.

The toothpaste used is a standard opaque dentrifice prepared by the addition of (in g):

| | |
|---|---|
| Glycerol | 25 |
| Sodium saccharinate | 0.15 |
| EDTA 4 NA | 0.10 |
| Sodium monofluorophosphate | 1.00 |
| Silica | 5.00 |
| Tween 20 | 2.00 |
| Sodium metaphosphate | 30.00 |
| Titanium dioxide | 0.20 |
| Hydroxyethylcellulose | 0.75 |
| Aqua | 100 c.s.p |

A blank sample was tested which did not contain LAE or any other added product.

A control sample contained LAE in a concentration of 7,500 ppm. The same concentration of LAE was present in all further investigated samples.

The products which were investigated were SDS (produced by Merck), sucralose (produced by Ferrer grupo), MK22 (produced by Virginia Dare), MM24 (produced by Virginia Dare), β-cyclodextrin (produced by Wacker), NAF®C (produced by Ogawa), NHDC (produced by Ferrer grupo), mono ammonium glycyrrhizinate (produced by Cognis), 501521T (produced by Firmenich), 510522T (produced by Firmenich), mentholyptus (produced by Century International Limited), menthol (produced by Flavour House Ireland) and xylitol (produced by Roquette).

TABLE 4

| | Organoleptic |
|---|---|
| Sample | result |
| Blank | 1.5 |
| Control sample | 5.4 |
| MK22 (2,000 ppm) | 2.8 |
| MM24 (2,000 ppm) | 2.8 |
| β-cyclodextrin (2,000 ppm) | 2.7 |
| SDS (1,960 ppm) | 2.9 |
| SDS (3,330 ppm) | 2.8 |
| SDS (1,960 ppm) + sucralose (1,000 ppm) | 2.5 |
| SDS (3,330 ppm) + sucralose (1,000 ppm) | 2.3 |
| SDS (1,960 ppm) + NAF ® C (5,000 ppm) + | 2.4 |
| sucralose (1,000 ppm) + NHDC (60 ppm) | |
| SDS (1,960 ppm) + sucralose (1,000 ppm) + | 2.3 |
| NHDC (60 ppm) | |
| SDS (3,330 ppm) + sucralose (1,000 ppm) + | 1.9 |
| NHDC (60 ppm) | |
| SDS (1,330 ppm) + sucralose (5,000 ppm) + | 2.1 |
| NHDC (60 ppm) + glycyrrhizinate (1,000 ppm) | |
| SDS (1,960 ppm) + sucralose (5,000 ppm) + | 2.2 |
| NHDC (60 ppm) + glycyrrhizinate (1,000 ppm) | |
| sucralose (5,000 ppm) + NHDC (60 ppm) + | 2.2 |
| 501521T (6,000 ppm) + NAF ® C (5,000 ppm) | |
| sucralose (5,000 ppm) + NHDC (60 ppm) + | 2.4 |
| 501522T (6,000 ppm) + NAF ® C (5,000 ppm) | |
| sucralose (5,000 ppm) + NHDC (60 ppm) + | 1.7 |
| 501521T (6,000 ppm) + NAF ® C (5,000 ppm) + | |
| glycyrrhizinate (1,000 ppm) | |
| mentholyptus (5,000 ppm) + xylitol (13,000 ppm) + | 1.6 |
| sucralose (1,000 ppm) | |
| menthol (2,000 ppm) + xylitol (15,000 ppm) + | 1.6 |
| sucralose (2,000 ppm) | |

### Comparative Example 4

The sweetening agents sorbitol and lactilol were investigated in the same test as described in example 11.

The samples were prepared in similar manner, the concentration of LAE was 7,500 ppm.

Sorbitol was produced by Danisco, lactitol by CarboMer.

TABLE 5

| | Organoleptic |
|---|---|
| Sample | result |
| Control | 5.4 |
| Sorbitol (200,000 ppm) | 4.9 |
| Lactitol (200,000 ppm) | 5.1 |

### Example 12

The taste masking effect of the test compound lysozyme on methyl-decanoyl-lysine acetate (MDLA) was investigated in a carbonated oral juice drink (manufactured by Hausmann S.A.).

Lysozyme was produced by RADA, MDLA was produced by Laboratorios Miret S.A.

The food matrix studied was the same as in example 1, the cationic surfactant MDLA was present at a concentration of 200 ppm, preparation and determination were as described in example 1.

The results of the study are given in table 6.

### Example 13

The taste masking effect of the test compound mono ammonium glycyrrhizinate (producer: Cognis) with MDLA was investigated in the manner as described in example 12.

The results of the study are given in table 6.

### Example 14

The taste masking effect of the test compound sodium acetate (producer: Panreac) with MDLA was investigated in the manner as described in example 12.

The results of the study are given in table 6.

### Example 15

The taste masking effect of sodium dodecyl sulfate (SDS; producer: Merck) with MDLA was investigated in the manner as described in example 12.

The results of the study are given in table 6.

TABLE 6

| | Organoleptic |
|---|---|
| Sample | results |
| Blank | 1.3 |
| Control | 5.3 |
| lysozyme (2,500 ppm) | 2.7 |
| glycyrrhizinate (1,000 ppm) | 2.4 |
| sodium acetate (10,000 ppm) | 2.8 |
| SDS (3,320 ppm) | 2.6 |

### Comparative Example 5

The taste masking effect of plain sugar (producer: Quimidroga) on MDLA was investigated in the manner as described in example 12.

The results of the study are given in table 7.

### Comparative Example 6

The taste masking effect of brown sugar (produced by Imperial sugar) with MDLA was investigated in the manner as described in example 12.

The results of the test are given in table 7.

### Comparative Example 7

The taste masking effect of sodium glutamate (produced by Fluka) with MDLA was investigated in the manner as described in example 12.

The results of the study are given in table 7.

TABLE 7

| | Organoleptic |
|---|---|
| Sample | results |
| Blank | 1.3 |
| Control | 5.3 |
| sugar (10,000 ppm) | 5.1 |
| brown sugar (10,000 ppm) | 5.3 |
| sodium glutamate (1,000 ppm) | 5.4 |

### Example 16

Determination of the taste masking in toothpaste.

The toothpaste used was produced in the manner described in example 11.

A blank sample was tested which did not contain methyl-decanoyl-lysine acetate (MDLA) or any other added product.

A control sample contained MDLA at a concentration of 7,500 ppm. The same concentration of MDLA was present in all further investigated samples.

The products which were investigated were SDS (produced by Merck), sucralose (produced by Ferrer grupo), NAF® C (produced by Ogawa), NHDC (produced by Ferrer grupo), ammonium glycyrrhizinate (produced by Cognis), 501521T (produced by Firmenich) and 510522T (produced by Firmenich), mentholyptus (produced by Century International Limited), menthol (produced by Flavour House Ireland) and xylitol (produced by Roquette).

The results of the study are given in table 8.

TABLE 8

| | Organoleptic |
|---|---|
| Sample | result |
| Blank | 1.5 |
| Control | 5.5 |
| SDS (3,330 ppm) | 2.9 |
| SDS (3,330 ppm) + sucralose (1,000 ppm) | 2.6 |
| SDS (1,960 ppm) + NAF ® C (5,000 ppm) + | 2.7 |
| sucralose (1,000 ppm) + NHDC (60 ppm) | |
| SDS (3,330 ppm) + sucralose (1,000 ppm) + | 2.2 |
| NHDC (60 ppm) | |
| SDS (1,960 ppm) + sucralose (5,000 ppm) + | 2.4 |
| NHDC (60 ppm) + glycyrrhizinate (1,000 ppm) | |
| sucralose (5,000 ppm) + NHDC (60 ppm) + | 2.2 |
| 501521T (6,000 ppm) + NAF ® C (5,000 ppm) | |
| sucralose (5,000 ppm) + NHDC (60 ppm) + | 2.2 |
| 501521T (6,000 ppm) + NAF ® C (5,000 ppm) + | |
| glycyrrhizinate (1,000 ppm) | |
| mentholyptus (5,000 ppm) + xylitol (13,000 ppm) + | 1.9 |
| sucralose (1,000 ppm) | |
| menthol (2,000 ppm) + xylitol (15,000 ppm) + | 2.0 |
| sucralose (2,000 ppm) | |

1. A combination having antimicrobial activity comprising as a first component a cationic surfactant, derived from the condensation of fatty acids and esterified dibasic amino acids, and having the formula (1): 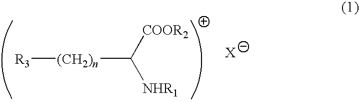
where:
X⁻ is a counter ion derived from an inorganic or organic acid,
R₁: is a straight alkyl chain of a saturated fatty acid or a hydroxy acid having 8 to 14 carbon atoms linked to the α-amino group via an amide bond,
R₂: is a straight or branched alkyl chain from 1 to 18 carbon atoms or an aromatic group and
R₃: is selected from the group consisting of: 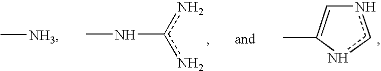
where n is from 0 to 4;
with a second component selected from the group consisting of sucralose, neohespiridin, β-cyclodextrin, mono ammonium glycyrrhizinate, banana, mentholyptus, sodium dodecyl sulphate, anetol, menthol, thaumatin, adenosine monophosphate, aloten, arginine, sodium acetate, arilic acids, ferulic acid, caffeic acid, sclareolide, maltol, anane, phosphatidic acid, eucalyptol, lactisole, lysozyme, lactoglobulin, timol, borneol, acetol, phosphothreonine, phosphotyrosine, phosphoserine, Masking flavour 501521T, Masking flavour 501522T, saccharine, aspartame, MK22 N&A FL for masking #25682, MM24 Prosweet N&A FL Enhancer, neodiosmin, xylitol, stevia and Natural and Functional Flavour (NAF®).

2. The combination of claim 1, wherein the compound of formula (1) is the ethyl ester of the lauramide of the arginine monohydrochloride (LAE).

3. The combination of claim 1 wherein the second component is at least one selected from the group consisting of sucralose, lysozyme, neohespiridin (NHDC), mono ammonium glycyrrhizinate (MAG), sodium dodecyl sulfate (SDS), NAF®, Masking flavour 501521T, β-cyclodextrin, MK22 N&A FL for masking #25682, MM24 Prosweet N&A FL Enhancer, mentholyptus, menthol and xylitol.

4. The combination of claim 1, wherein the ratio by weight of the compound of the formula (1) to the second component is 1:300 to 2,000:1.

5. The combination of claim 1, wherein the ratio by weight of the compound of the formula (1) to the second component is between 1:50 and 200:1.

6. The combination of claim 1, wherein X⁻ is selected from the group consisting of Br⁻, Cl⁻ and HSO₄⁻

7. The combination of claim 2, wherein the second component is at least one selected from the group consisting of sucralose, lysozyme, neohespiridin (NHDC), mono ammonium glycyrrhizinate (MAG), sodium dodecyl sulfate (SDS), NAF®, Masking flavour 501521T, β-cyclodextrin, MK22 N&A FL for masking #25682, MM24 Prosweet N&A FL Enhancer, mentholyptus, menthol and xylitol.

8. The combination of claim 6, wherein the second component is at least one selected from the group consisting of sucralose, lysozyme, neohespiridin (NHDC), mono ammonium glycyrrhizinate (MAG), sodium dodecyl sulfate (SDS), NAF®, Masking flavour 501521T, β-cyclodextrin, MK22 N&A FL for masking #25682, MM24 Prosweet N&A FL Enhancer, mentholyptus, menthol and xylitol.

9. The combination of claim 2, wherein the ratio by weight of the compound of the formula (1) to the second component is 1:300 to 2,000:1.

10. The combination of claim 3, wherein the ratio by weight of the compound of the formula (1) to the second component is 1:300 to 2,000:1.

11. The combination of claim 6, wherein the ratio by weight of the compound of the formula (1) to the second component is 1:300 to 2,000:1.

12. The combination of claim 2, wherein the ratio by weight of the compound of the formula (1) to the second component is between 1:50 and 200:1.

13. The combination of claim 3, wherein the ratio by weight of the compound of the formula (1) to the second component is between 1:50 and 200:1.

14. The combination of claim 6, wherein the ratio by weight of the compound of the formula (1) to the second component is between 1:50 and 200:1.
